(19) United States
(12) Patent Application Publication
(10) Pub. No.: US 2012/0085415 A1
(43) Pub. Date: Apr. 12, 2012

(54) WELL DRAIN SYSTEM FOR USE WITH MULTI-WELL SYNTHESIZER

(75) Inventors: Mike Bailey, Gig Harbor, WA (US); Gary McLuen, Port Townsend, WA (US)

(73) Assignee: GENEFORGE, INC., Redwood City, CA (US)

(21) Appl. No.: 13/269,309

(22) Filed: Oct. 7, 2011

Related U.S. Application Data
(60) Provisional application No. 61/391,577, filed on Oct. 8, 2010.

(51) Int. Cl. F15D 1/00; B01L 3/00

(52) U.S. Cl. 137/1; 422/552; 422/551

(57) ABSTRACT

A well drain system for use with a synthesizer. The well drain system comprises a well plate, a well adapter plate and a drain plate detachably coupled together. The well plate comprises a matrix of wells for receiving one or more vials, wherein the matrix has a plurality of rows. The well adapter plate comprises an arched plate body and a plurality of apertures in communication with one or more of the wells. The drain plate comprises a plurality of channels in communication with one or more of the apertures. As a result, a user is able to selectively drain the vials found within individual rows of the well plate instead of all the vials at once.

### RELATED APPLICATIONS

This patent application claims priority under 35 U.S.C. 119(e) to the co-pending U.S. Provisional Patent Application Ser. No. 61/391,557 filed Oct. 8, 2010, and entitled “WELL DRAIN SYSTEM FOR USE WITH MULTI-WELL SYNTHESIZER,” which is hereby incorporated by reference.

### FIELD OF THE INVENTION

The present invention relates to the field of valve systems. More particularly, the present invention relates to well drain systems for use within synthesizers that utilize multiple banks of vials to synthesize custom sequence defined oligonucleotides, polymers, and other organic compounds.

### BACKGROUND OF THE INVENTION

Oligonucleotides are playing an increasingly important role in diagnostic medicine, forensic medicine, and molecular biology research. In addition to oligonucleotides, polymers such as peptides, polynucleotides, and other organic chains are also very important in scientific research.

Accordingly, the use of and demand for synthetic oligonucleotides, polymers, and organic chains has increased. In turn, this has spawned development of new synthesis systems and methods for basic procedures for custom sequence defined oligonucleotides, polymers, and other organic chains.

Typically, the present automated systems and methods place a solid support such as controlled pore glass beads (CPG) into a plurality of individual vials which provide a stable anchor to initiate the synthesis process. Using a series of valves, the selected reagents are sequentially placed into the appropriate vial in a predetermined sequence. Contact of the reagent with the CPG inside each of the vials causes a reaction that results in sequenced growth thereon. Sequential deposits of the selected reagents within the vials build the predetermined sequence.

A flushing procedure is typically utilized after a particular reagent is placed into one of the vials for a predetermined amount of time. While the particular reagent contacts the CPG a reaction produces a sequenced growth on the CPG. In conventional synthesis machines the flushing procedure is performed on all the vials simultaneously. During a flushing operation within conventional synthesis machines, all the reagents within the plurality of individual vials are flushed and expelled through a shared central orifice within the synthesis machine. After completion of a flushing operation, the plurality of vials are then capable of receiving another reagent.

A retaining device is customarily utilized to ensure that the CPG remains within the corresponding vial during the flushing procedure. This retaining device is located within each individual vial and is positioned to prevent the CPG from exiting the orifice during the flushing procedure.

In High Throughput DNA Synthesis in a MultiChannel Format, L. E. Sindelar and J. M. Jaklevic teach an approach to high throughput parallel DNA synthesis in which a multi-vial format is utilized. The reactions are carried out in open vials. Each vial contains CPG to form the substrate for the synthesis and a high density filter bottom to retain the CPG within each vial. There is a common vacuum line that is coupled to all the vials. This common vacuum line simultaneously flushes the material contained within all the vials. The synthesis of a DNA sequence is carried out by directly dispensing reagents into individual reaction vials. A computer controls the sequence in which reagents are dispensed and timing periodic flushing operations to expel material from the reaction vials.

U.S. Pat. No. 5,529,756, by Brennan, teaches an apparatus and method for polymer synthesis utilizing arrays. This apparatus includes an array of nozzles with each nozzle coupled to a reservoir containing a reagent and a base assembly having an array of reaction vials. A transport mechanism aligns the reaction vials and selected nozzles to deposit an appropriate reagent to a selected vial. Each of the reaction vials has an inlet for receiving a reagent and an outlet for expelling a material. To perform a flushing operation, this apparatus creates a pressure differential between the inlet and outlet of the array of vials. During the flushing operation, material within each of the array of vials are simultaneously expelled.

U.S. Pat. No. 7,192,558 B2, by McLuen, teaches a multi-well rotary synthesizer that includes a controller, a plurality of precision fit vials circularly arranged in multiple banks on a circular cartridge, a drain corresponding to each bank of vials, a chamber bowl, a plurality of valves for delivering reagents to selective vials, and a waste tube system for purging material from the vials. The banks of vials on the circular cartridge can be selectively purged, allowing the banks of vials to be used to synthesize different polymer chains. Further, the multiple banks of valves provide an additional number of reagent choices while operating in a serial mode and faster reagent distribution while operating in a parallel mode.

In the synthesizer taught by McLuen, the plurality of vials are held within the circular cartridge and are divided among individual banks. Preferably, each individual bank of vials has a corresponding drain. There is at least one waste tube system for expelling the reagent solution from vials within a particular bank of vials when the waste tube system is coupled to the corresponding drain. The circular cartridge holding the plurality of vials rotates relative to the stationary banks of valves and the waste tube system. The controller controls a motor to rotate the circular cartridge. The controller also operates the banks of valves and the waste tube system in response to the required sequence of dispensing various reagent solutions and flushing appropriate vials in order to create the desired polymer chain.

### SUMMARY OF THE INVENTION

A well drain system is for use with a multi-well synthesizer. The well drain system comprises a well plate, a well adapter plate and a drain plate detachably coupled together. The well plate comprises a matrix of wells for receiving one or more vials, wherein the matrix has a plurality of rows. The well adapter plate comprises an arched plate body and a plurality of apertures in communication with one or more of the wells. The drain plate comprises a plurality of channels in communication with one or more of the apertures. As a result, a user is able to selectively drain the vials found within individual rows of the well plate instead of all the vials at once. This is able to be accomplished without the individual rows needing to be disconnected or reconnected to the drain/adapter plate during operation.

One aspect of the present application is directed to a well drain system for use with a synthesizer containing one or more vials. The well drain system comprises a well plate having a plurality of wells distributed across the well plate in a plurality of rows, a well adapter plate having a plurality of apertures, wherein the apertures are in communication with the wells, a drain plate having one or more channels that are each in communication with one or more of the rows via the apertures, wherein the well plate, well adapter plate and drain plate are detachably coupled such that individual rows of the well plate are able to be selectively drained. In some embodiments, the well plate is substantially rectangular. In some embodiments, the wells are arranged on the well plate in a linear matrix including the plurality of rows. In some embodiments, the well plate further comprises an angled chamfer along a corner of the well plate having a preselected angle and length. In some embodiments, the well adapter plate further comprises a cavity for receiving the well plate, wherein the cavity is dimensioned such that the angled chamfer only permits the well plate to couple with the well adapter plate within the cavity in a single orientation. In some embodiments, the well plate comprises 2, 4, 6, 8, 96, 192, 384 or 1536 wells. In some embodiments, the well adapter plate further comprises an adapter body having first end and a second end, and further wherein the adapter body arches between the first end and the second end such that an increased seal is created around the wells when the well adapter plate is coupled to the well plate and/or the drain plate. In some embodiments, the highest point of the arch within the adapter body is substantially in the center of the adapter body. Alternatively, the arch is a downward arch such that the lowest point of the arch within the adapter body is substantially in the center of the adapter body. In some embodiments, the adapter body is substantially rectangular and the first end and second end correspond to the two shorter sides of the adapter body. Alternatively, the adapter body is substantially rectangular and the first end and second end correspond to the two longer sides of the adapter body. In some embodiments, the adapter body further comprises one or more additional arches oriented along one or more second axis distinct from a first axis of the arch. In some embodiments, at least one of the one or more additional arches is oriented perpendicular to the arch. The system further comprises one or more gaskets having a plurality of gasket apertures that correspond to the wells or the apertures, wherein the gaskets are positioned between two or more of the well plate, the well adapter plate and the drain plate, wherein the gaskets thereby provide a gas-tight seal between one or both of the wells and the apertures, and the apertures and the channels. In some embodiments, the drain plate further comprises a recess on a top surface of the drain plate for receiving at least a portion of at least one of the gaskets. The system further comprises one or more coupling mechanisms for coupling the well plate, well adapter plate, drain plate and gaskets together. In some embodiments, the coupling mechanisms are sized such that when in a closed position the coupling mechanisms cause the well plate, well adapter plate, drain plate and gaskets to couple to each other forming a gas-tight seal wherein the arch of the well adapter plate compresses two or more of the group consisting of the gaskets, the well plate and the drain plate. In some embodiments, the one or more vials each have a hollow body, one or more fits and one or more narrowing points along the body such that the vials form an gas-tight seal with each of the wells when inserted into the wells.

Another aspect of the present application is directed to a method of draining a well drain system for use with a synthesizer containing one or more vials having bottom openings. The method comprises inserting the one or more vials into a plurality of wells distributed across a well plate in a plurality of rows such that the bottom openings are in communication with the wells, positioning the well plate at least partially within a well adapter plate having a plurality of apertures, such that the apertures are in communication with the wells, positioning beneath the well adapter plate a drain plate having one or more channels such that each of the channels are in communication with one or more of the rows via the apertures, distributing one or more solutions into one or more of the vials and selectively draining one or more of the rows containing at least one of the vials individually through the well adapter plate and the drain plate. In some embodiments, the one or more rows are selectively drained via pressure differential. In some embodiments, the well plate is substantially rectangular. In some embodiments, the wells are arranged on the well plate in a linear matrix including the plurality of rows. In some embodiments, the well plate further comprises an angled chamfer along a corner of the well plate having a preselected angle and length. In some embodiments, the well adapter plate further comprises a cavity for receiving the well plate, wherein the cavity is dimensioned such that the angled chamfer only permits the well plate to couple with the well adapter plate within the cavity in a single orientation. In some embodiments, the well plate comprises 2, 4, 6, 8, 96, 192, 384 or 1536 wells. In some embodiments, the well adapter plate further comprises an adapter body having first end and a second end, and further wherein the adapter body arches between the first end and the second end such that an increased seal is created around the wells when the well adapter plate is coupled to the well plate and/or the drain plate. In some embodiments, the highest point of the arch within the adapter body is substantially in the center of the adapter body. Alternatively, the arch is a downward arch such that the lowest point of the arch within the adapter body is substantially in the center of the adapter body. In some embodiments, the adapter body is substantially rectangular and the first end and second end correspond to the two shorter sides of the adapter body. Alternatively, the adapter body is substantially rectangular and the first end and second end correspond to the two longer sides of the adapter body. In some embodiments, the adapter body further comprises one or more additional arches oriented along one or more second axis distinct from a first axis of the arch. In some embodiments, at least one of the one or more additional arches is oriented perpendicular to the arch. The method further comprises positioning one or more gaskets between two or more of the well plate, the well adapter plate and the drain plate, wherein the gaskets have a plurality of gasket apertures that correspond to the wells or the apertures and provide a gas-tight seal between one or both of the wells and the apertures, and the apertures and the channels. In some embodiments, the drain plate further comprises a recess on a top surface of the drain plate for receiving at least a portion of at least one of the gaskets. The method further comprises coupling the well plate, well adapter plate, drain plate and gaskets together with one or more coupling mechanisms. In some embodiments, when the coupling mechanisms are in a closed position, the coupling mechanisms cause the well plate, well adapter plate, drain plate and gaskets to couple to each other forming a gas-tight seal such that the arch of the well adapter plate compresses two or more of the group consisting of the gaskets, the well plate and the drain plate. In some embodiments, the one or more vials each have a hollow body, one or more fits and one or more narrowing points along the body such that the vials form an gas-tight seal with each of the wells when inserted into the wells.

Yet another aspect of the present application is directed to a well adapter plate for receiving one or more vials in a well drain system. The well adapter plate comprises a plate body having a first end and a second end, one or more apertures within the plate body, wherein the plate body arches between the first end and the second end such that an increased seal is created around the apertures when the adapter plate is coupled within the well drain system. In some embodiments, the highest point of the arch within the plate body is substantially in the center of the plate body. Alternatively, the arch is a downward arch such that the lowest point of the arch within the plate body is substantially in the center of the plate body. In some embodiments, the plate body is substantially rectangular and the first end and second end correspond to the two shorter sides of the plate body. Alternatively, the plate body is substantially rectangular and the first end and second end correspond to the two longer sides of the plate body. In some embodiments, the plate body further comprises one or more additional arches oriented along one or more second axis distinct from a first axis of the arch. In some embodiments, at least one of the one or more additional arches is oriented perpendicular to the arch. In some embodiments, the plate body further comprises a cavity for receiving a well plate having a plurality of wells and an angled chamfer along one corner of the well plate, wherein the cavity is dimensioned such that the angled chamfer only permits the well plate to couple with the adapter plate within the cavity in a single orientation. In some embodiments, each of the apertures have a top opening sized and positioned to receive the output of one or more of the wells.

Another aspect of the present application is directed to a well drain system for use with a synthesizer containing one or more vials. The well drain system comprises a substantially rectangular well plate having a plurality of wells for receiving the one or more vials thereby forming a gas-tight seal, wherein the wells are distributed across the well plate in a matrix having a plurality of rows, a well adapter plate having an arched body and a plurality of apertures, wherein the apertures are in gas-tight communication with the wells such that each of the apertures receive the output of less than all of the vials via the wells, a drain plate having one or more channels that are each in communication with one or more of the rows via the apertures such that each channel is coupled to less than all of the one or more rows forming a first gas-tight seal and at least one coupling device for detachably coupling the well plate forming a second gas-tight seal, well adapter plate and drain plate to each other such that a pressure differential applied to one of the channels is able to selectively drain the vials in less than all of the rows of the well plate. In some embodiments, the well plate further comprises an angled chamfer along a corner of the well plate having a preselected angle and length. In some embodiments, the well adapter plate further comprises a cavity for receiving the well plate, wherein the cavity is dimensioned such that the angled chamfer only permits the well plate to couple with the well adapter plate within the cavity in a single orientation. The system further comprises one or more gaskets having a plurality of gasket apertures that correspond to the wells or the apertures, wherein the gaskets are positioned between two or more of the well plate, the well adapter plate and the drain plate, wherein the gaskets thereby increase the gas-tight seal between one or both of the wells and the apertures, and the apertures and the channels. In some embodiments, the drain plate further comprises a recess on a top surface of the drain plate for receiving at least a portion of at least one of the gaskets. In some embodiments, the coupling device is one or more clamps that are sized such that when in a closed position the clamps cause the well plate, well adapter plate, drain plate and gaskets to couple to each other forming a gas-tight seal wherein the arch of the well adapter plate compresses two or more of the group consisting of the gaskets, the well plate and the drain plate. In some embodiments, the one or more vials each have a hollow body, one or more fits and one or more narrowing points along the body such that the vials form an gas-tight seal with each of the wells when inserted into the wells. In some embodiments, the well plate comprises 2, 4, 6, 8, 96, 192, 384 or 1536 wells.

### BRIEF DESCRIPTION OF THE DRAWINGS

FIG. 1 illustrates a well drain system incorporated into a synthesizer according to some embodiments.

FIG. 2A illustrates a perspective view of a well drain system detachably coupled together according to some embodiments.

FIG. 2B illustrates an exploded perspective view of a well drain system according to some embodiments.

FIG. 2C illustrates a front view of a well drain system detachably coupled together according to some embodiments.

FIG. 2D illustrates an exploded front view of a well drain system according to some embodiments.

FIG. 3A illustrates a top view of a well plate in accordance with some embodiments.

FIG. 3B illustrates a side cross sectional view of a well plate in accordance with some embodiments.

FIG. 3C illustrates a zoomed in cross sectional view of a well plate in accordance with some embodiments.

FIG. 3D illustrates a zoomed in cross sectional view of a well in accordance with some embodiments.

FIG. 4A illustrates a front cross sectional view of a well adapter plate coupled with a well plate according to some embodiments.

FIG. 4B illustrates a zoomed in cross sectional view of the border between a well adapter plate and a well plate coupled together.

FIG. 4C illustrates a front view of a well adapter plate with an arch according to some embodiments.

FIG. 5A illustrates a front cross sectional view of a well drainage plate according to some embodiments.

FIG. 5B illustrates a front cross sectional view of a well drain system according to some embodiments.

FIG. 5C illustrates a side view of a well drainage plate according to some embodiments.

FIG. 6 illustrates a cross sectional view of a vial according to some embodiments.

FIG. 7 illustrates a flow chart of a well draining method using the well drainage system according to some embodiments.

### DETAILED DESCRIPTION OF THE PRESENT INVENTION

While the present invention will be described with reference to several specific embodiments, the description is illustrative of the present invention and is not to be construed as limiting the invention. Various modifications to the present invention can be made without departing from the scope and spirit of the present invention. For the sake of clarity and a better understanding of the present invention, common components share common reference numerals throughout various figures.

The well drain system of the present application is for providing well drainage for an associated synthesizer 100. The synthesizer 100 is designed for building a polymer chain by sequentially adding polymer units to a solid support in a reagent solution. The solid support generally resides within a vial and various reagent solutions are sequentially added to the vial. Before an additional reagent solution is added to the vial, the previous reagent solution is preferably purged from the vial. Although, the synthesizer 100 is particularly suited for building sequence defined oligonucleotides, the synthesizer 100 is also configured to build any other desired polymer chain or organic compound. The term “polymer chain” is defined as a unit that is bound to other units of the same or different kind to form a polymer chain, such as oligonucleotides and peptide chains. It is important to note that although the present invention is described in context of specific applications, the present invention should not be limited to these specific examples disclosed herein.

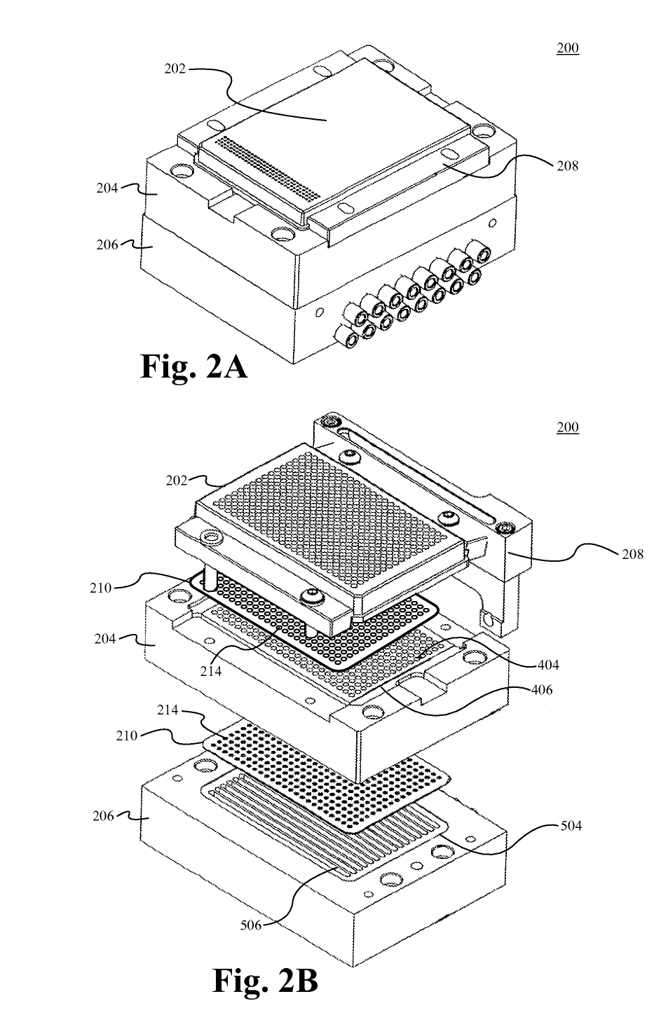

The synthesizer 100 comprises a plurality of input valves, one or more vials and a well drain system. Within the well drain system there is a well plate having a matrix of wells for receiving the one or more vials. For each row of wells in the matrix, there is at least one vial inserted into a well of the row. The inserted vials are designed for holding solid supports and for containing reagent solutions such that polymer chains are able to be synthesized. The plurality of input valves are able to selectively dispense a reagent solution into one or more of the vials inserted into the wells according to the position of the vials within the matrix. The well drain system 200 (see FIGS. 2A-2D) of the synthesizer 100 allows each row of vials/wells to be selectively purged of the presently held reagent solution. A well adapter plate of the well drain system 200 is able to have an arched body such that when it is coupled in place within the well drain system 200 the well plate conforms to and/or is flexed by this arch thereby creating a gas tight seal for each individual row and/or throughout the system. Alternatively, when the well adapter plate is coupled in place within the well drain system 200 the arch is flattened thereby increasing the strength of a gas-tight seal through the system. The well plate includes an angled chamfer that matches a cavity of the well adapter plate such that the well plate is always oriented correctly in order to fit within the well adapter plate cavity. Also, the vials have one or more narrow points, a top seal, and a precisely dimensioned bottom opening such that they form a gas-tight seal with the wells and prevent the reagent solution from being drained due to gravity unless a pressure differential is applied to the vial bottom opening.

Additional valves are able to provide the synthesizer 100 with greater flexibility. For example, a bank of valves are able to distribute reagent solutions to a particular row of vials/wells in a parallel fashion to minimize the processing time. Alternatively, multiple banks of valves are able to distribute reagent solutions to a particular row of vials/wells in series thus allowing the synthesizer 100 to hold a larger number of different reagent solutions, thus being able to create complex polymer chains. Accordingly, the synthesizer 100 with the drain system provides the advantages of selective row drainage, increased gas-tight sealing, ensured well plate orientation correctness and the effective gas-tight sealing and drainage of the vials.

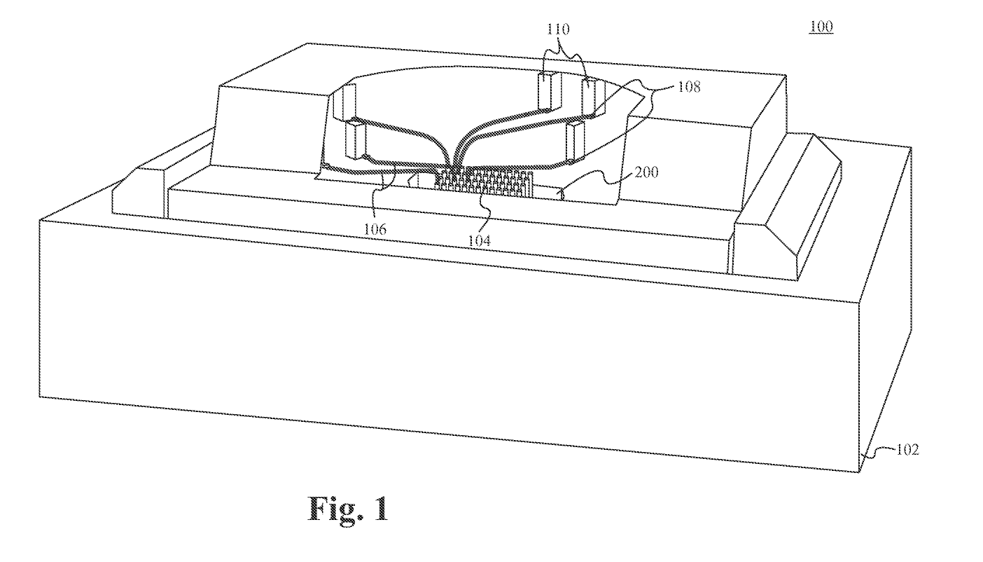

FIG. 1 illustrates an exterior perspective view of a synthesizer 100 according to some embodiments. As illustrated in FIG. 1, the synthesizer 100 includes a base 102, a well drainage system 200, a plurality of rows of vials 104, a plurality of dispense lines 106 and a plurality of valves 108. The vials 104 are shown inserted into wells of the drainage system 200 which form a well matrix having a plurality of rows. Each of the valves are able to selectively dispense a reagent solution into one or more of the vials 104. The vials 104 are able to retain a solid support such as CPG and hold a reagent solution. In some embodiments, a loaded polystyrene support or amino polystyrene support are able to be substituted for the CPG in order to grow a polymer chain. Alternatively, the CPG is able to be replaced or supplemented with one or more of a loaded polystyrene support, an amino polystyrene support, or other supports for DNA and/or RNA synthesis as are well known in the art. Further, as each reagent solution is sequentially deposited within the vial 104 and sequentially purged therefrom, a polymer chain is generated. Additionally, there is able to be a plurality of reservoirs 110 coupled to the plurality of valves 108, wherein each reservoir 110 contains a specific reagent solution to be dispensed through one of the plurality of valves 108. In some embodiments, the plurality of valves 108 are coupled to the base 102 of the synthesizer 100. In some embodiments, each of the plurality of reservoirs 110 is pressurized. As a result, as each valve 108 is opened, a particular reagent solution from the corresponding reservoir 110 is dispensed into a corresponding vial 104 via the pressure.

Each of the plurality of dispense lines 106 is able to be coupled to a corresponding one of the valves within the plurality of valves 108. Each of the plurality of dispense lines 106 is able to provide a conduit for transferring a reagent solution from the valve 108 to a corresponding vial 104. The plurality of dispense lines 106 are able to be flexible and semi-resilient in nature. In some embodiments, the plurality of dispense lines 106 are each coated with Teflon® which is more resistant to deterioration upon contact with reagent solutions and provides an adequate seal between the plurality of valves 108 and the plurality of dispense lines 106. Further, each of a plurality of fittings is able to be coupled to one of the plurality of dispense lines 106. The plurality of fittings are able to prevent the reagent solution from splashing outside a vial 104 as the reagent solution is dispensed from a cap to a particular vial 104 positioned below the cap. It should be noted that any number of wells, vials 104, lines 106, valves 108, and reservoirs are able to be utilized with the appropriate scaling of the synthesizer 100 as needed.

In operation, each of the valves 108 selectively dispenses a reagent solution through one of the plurality of dispense lines 106 into one or more selected vials 104 as determined by the position of the vials 104 within the well matrix of the well drainage system 200 (described in detail below). In particular, the well drainage system 200 is controlled and moved by a servo controller (not shown) relative to the reagent distributing valves 108. The servo controller moves the well drainage system 200 (including the plurality of vials 104 inserted into wells within the well matrix) according to known coordinates (e.g. x,y coordinates) of the wells/vials within the well matrix such that the appropriate vials 104 are positioned underneath the desired reagent valves 108 for dispensing the desired reagent into the vials. For example, the well matrix is able to be considered an (X,Y) plane wherein each of the wells in the columns/rows of the matrix are represented by points on the (X,Y) plane. The first well is at position (1,1) and the last well is at the position (# of columns, # of rows). Thus, the servo controller is able to track the position of each of the vials 104 and move the vials 104 under a sequence of reagent distributing valves 108 such that a desired polymer chain is created. Further, the plurality of valves 108 are able to simultaneously and independently dispense reagent solutions into corresponding vials 104. It should be noted that the specifics of the operation of the servo controller and other portions of the synthesizer 100 (e.g. user interface, computing device) are well known in the art and therefore not repeated here for the sake of brevity.

FIGS. 2A-2D illustrate the well drainage system 200 according to some embodiments. The well drainage system 200 comprises a well plate 202, a well adapter plate 204, a drainage plate 206 and a coupling mechanism 208. In some embodiments, one or more of the well plate 202, well adapter plate 204, drainage plate 206 and or coupling mechanism 208 are formed of polypropylene. Alternatively, one or more of the well plate 202, well adapter plate 204, drainage plate 206 and or coupling mechanism 208 are able to be formed of other suitable material(s) as are well known in the art. In some embodiments, the well adapter plate 204 is formed of a material that is more rigid than the material that forms the well plate 202 such that the well plate 202 is flexed and/or compressed by the well adapter plate 204 forming a gas tight seal when the well plate 202 and the well adapter plate 204 are coupled together. For example, the well adapter plate 204 is able to be formed of a substantially rigid metal and the well plate 202 is able to be formed of a polyethylene which is relatively more flexible than the metal. Alternatively, the well plate 202 is able to be formed of the more rigid material than the well adapter plate 204 such that the well adapter plate 204 is flexed and/or compressed by the well plate 202 during coupling. The coupling mechanism 208 detachably couples the well plate 202, well adapter plate 204 and the drainage plate 206 together such that they form a gas tight unit. In some embodiments, the well plate 202 is coupled on top of the well adapter plate 204 which is coupled on top of the drainage plate 206. Alternatively, in some embodiments the well adapter plate 204 is omitted and the well plate 202 is coupled directly to the drainage plate 206. In some embodiments, the coupling mechanism 208 comprises one or more clamps. Alternatively, the coupling mechanism 208 comprises any combination of clamps, screws, latches, snap-fits or other coupling mechanisms as are well known in the art. In some embodiments, the system 200 comprises one or more additional coupling mechanisms for coupling two or more of the plates together, which comprises any combination of clamps, screws, latches, snap-fits or other coupling mechanisms as are well known in the art.

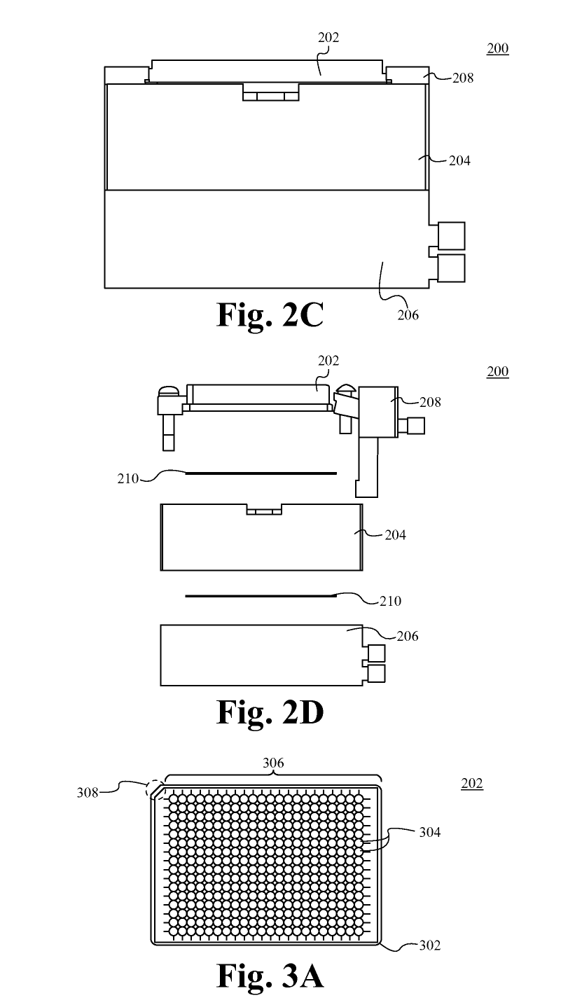

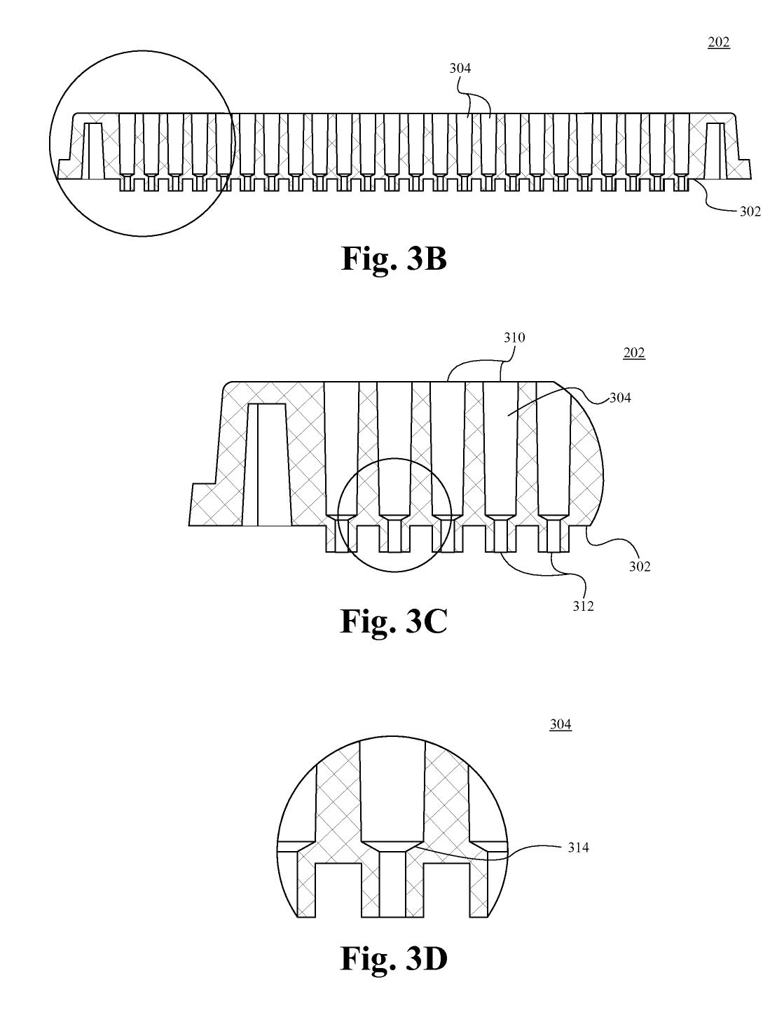

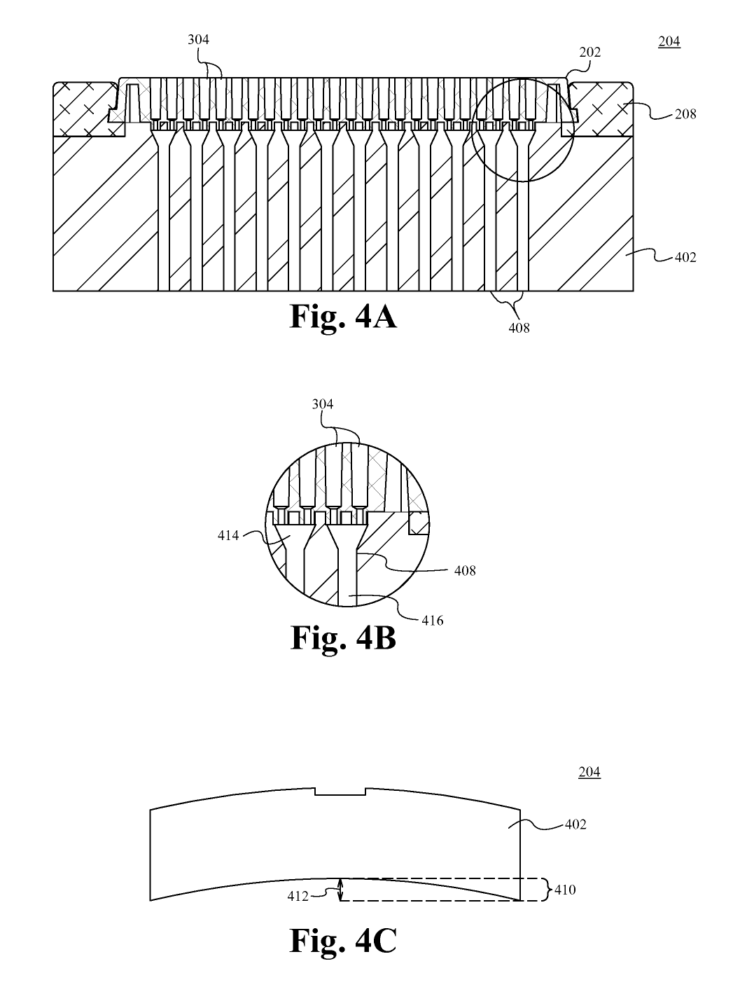

In some embodiments, the well drainage system 200 further comprises one or more gaskets 210. The gaskets 210 comprise a plurality of gasket apertures 214 and are positioned between the well plate 202 and the adapter plate 204 and/or between the adapter plate 204 and the drain plate 206 as shown in FIGS. 2B and 2D. In some embodiments, the gaskets 210 are made of compressible material that is able to be deformed when a force is applied and then spring back into its original shape when the force is removed as is well known in the art. The gasket apertures 214 traverse the width of the gasket 210. If the gasket 210 is designed to be inserted between the well plate 202 and the well adapter plate 204, the gasket apertures 214 are positioned such that they correspond to the bottom openings 312 of the wells 302 (see FIGS. 3C and 3D) of the well plate 202 when the gasket 210 is positioned underneath the well plate 202. Alternatively, if the gasket 210 is designed to be inserted between the well adapter plate 204 and the drainage plate 206, the gasket apertures 214 are positioned such that they correspond to the bottom openings of the adapter apertures 408 (see FIGS. 4A and 4B) of the adapter plate 204 when the gasket 210 is positioned underneath the adapter plate 204. In some embodiments, the gaskets 210 are shaped in order to fit within an adapter recess 406 within the top of the well adapter body 402 (see FIG. 4A). Alternatively, the gaskets 210 are shaped in order to fit within a drainage recess 504 (see FIG. 5) within the top of the drainage body 502. In some embodiments, the gaskets 201 only fully fit within the recesses 404, 504 when under compression such that the gaskets 201 are thinner. As a result, when the drainage system 200 including one or more gaskets 210 is detachably coupled together, the gaskets 210 are compressed and create a stronger gas-tight seal between the wells 302, the plates 202, 204, 206 and the whole system 200. Accordingly, the gaskets 210 of the present application provide the advantage of better preventing cross contamination of reagents between wells 302 and rows of wells 302.

As shown in FIGS. 3A-3D, the well plate 202 comprises a plate body 302 having an angled chamfer 308 and a well matrix including a plurality of wells 304 arranged in a plurality of rows 306. In some embodiments, the plate body 302 is substantially rectangular. Alternatively, the plate body 302 is able to be a number of different shapes as are well known in the art. In some embodiments, the well plate 202 includes 2, 4, 6, 8, 96, 192, 384 or 1536 wells. Alternatively, any number of wells 304 are able to be used. Additionally, the angle and depth of the angled chamfer 308 is able to be determined based on the shape of a cavity 406 (see FIGS. 2B and 4A) found on the top of the well adapter plate 204. Also, the plurality of wells 304 traverse the width of the plate body 302 such that they create corresponding openings on the top and bottom of the plate body 302. In some embodiments, the wells 304 are substantially perpendicular to the top surface of the plate body 302. Alternatively, the wells 304 are able to be angled.

In some embodiments as shown in FIGS. 3C and 3D, the wells 304 are dimensioned such that they form the same profile as the outside of the vials 104. This substantially matching profile is created in order to facilitate a gas-tight fit between the outer surface of the vials 104 and the inner surface of the wells 304. Specifically, the wells 304 narrow from their top opening 310 to their bottom opening 312 such that the top opening 310 is larger than the bottom opening 312. Further, the top opening 310 is able to have a perimeter or circumference that matches the outer circumference of the vials 104 such that a top protruding portion and outer surface of the vial 104 is able to easily form a gas-tight seal with the top opening 310. In some embodiments, the wells 304 comprise one or more narrowing points 314 as shown in FIG. 3D. It is understood that although FIG. 3D only shows a single narrowing point 314, the wells 304 are able to have any number of narrowing points. The one or more narrowing points 314 create distinct pressure points against vials 104 for better facilitating a gas-tight seal against the vials 104. Specifically, as a vial 104 is pushed down into the well 304, the distinct pressure points press inward against the vial 104, wherein this squeezing of the vial serves to prevent gas from moving between the vial 104 and the well 304. Indeed, in some embodiments, the wells 304 are dimensioned such that they are slightly smaller than the vials 104, thereby causing the vials 104 to be under compression from the wells 304 when inserted in the wells 304. As a result of this compression, the strength of the gas-tight seal is increased. Alternatively, the wells 304 are able to have any appropriate dimensions capable of receiving a vial 104.

FIGS. 4A-4C illustrate a well adapter plate 204 coupled with the well plate 202 according to some embodiments. The well adapter plate 204 comprises an adapter plate body 402, a cavity 406 and a plurality of adapter apertures 408. In some embodiments, the well adapter plate 204 also comprises a recess 404 dimensioned for receiving one or more gaskets 201 as described above. In some embodiments, the adapter plate body 402 is substantially rectangular such that it has a pair of longer sides and a pair of shorter sides. Alternatively, the adapter plate body 402 is able to have any shape capable of coupling to the well plate 202 and drain plate 206 as are well known in the art. In some embodiments, the adapter plate body 402 is substantially flat. Alternatively, the adapter plate body 402 includes one or more arches 410 having a maximum depth 412 as shown in FIG. 4C. Although as shown in FIG. 4C, the arch 410 is found on both the top and bottom of the adapter plate body 402, in some embodiments, either the bottom or top of the adapter plate body 402 is able to be flat such that only the other side (bottom or top) forms the arch 410. In some embodiments, the arch 410 is an upward arch centered on an axis parallel to the shorter sides of the adapter plate 204. In such embodiments, the highest point of the arch 410 is a line down the center of the adapter plate 204 perpendicular to the shorter sides. In some embodiments, the arch 410 is able to be centered on an axis perpendicular to the shorter sides of the adapter plate 204 such that the highest point is a centered line perpendicular to the longer sides. Alternatively, the arch 410 is able to be on any substantially horizontal axis of the adapter plate body 402, wherein the arch 410 is able to be centered or uncentered on the axis. In some embodiments, one or more additional arches are able to be centered or uncentered on additional different axis of the adapter plate body 402. For example, the body 402 is able to have a first arch along the longer sides and a second arch along the shorter sides. Alternatively, the one or more additional arches are able to be on the same axis as the arch 410 creating multiple undulations along the same axis. Further, in some embodiments, the arch 410 and or additional arches are able to be downward arches such that the highest point of the arches is able to be the opposing sides furthest from the center. In some embodiments, one or more of the arches 410 are able to have different rates of curvature such that they have different maximum depths 412.

As a result of the one or more arches 410, when coupled to the well plate 202 and/or the drain plate 206, the adapter plate body 402 (which is able to be more rigid than the well plate 202 and/or the drain plate 206) causes the well plate 202 and/or drain plate 206 (as well as any inserted gaskets 210) to compress and/or flex. Alternatively, in some embodiments the adapter plate body 402 is less rigid than the well plate 202 and/or the drain plate 206 such that when they are coupled together, the adapter plate body 402 is able to act like a flattened spring applying additional force to both the coupled well plate 202 and drain plate 206 (as well as any inserted gaskets 210). Thus, in either case, the present application provides the further advantage of increased force facilitating better gas-tight sealing of the drainage system 200 such that there is less of a possibility for leakage and cross contamination between wells/vials. In some embodiments, the well plate 202 and or drainage plate 206 also comprise an arch or arches having similar characteristics and effects as described herein with reference to the arch 410 of the adapter plate 204. It should be noted that the term “arch” as used herein is not limited to a hemispherical arch. Instead, the term “arch” also includes a pointed/pyramid configuration including one or more bending points, a half-arch wherein the “arch” is centered at an end of the body, or other non-flat configurations. Indeed, any non-flat body that when compressed creates a spring force is envisioned.

The cavity 406 (FIG. 2B) is able to be dimensioned such that it is able to receive the well plate 202. In some embodiments, the dimensioning is such that it matches the bottom profile of the well plate 202 and includes the angled chamfer 308 of the well plate 202. As a result, the present application provides the advantage of ensuring that the well plate 202 is inserted with the proper orientation into the well plate adapter's cavity 406. Specifically, because the angled chamfer 308 is positioned on a predetermined corner of the well plate 202 with dimensions that match the dimensions of a predetermined corner of the cavity 406, the well plate 202 is only able to be properly inserted into the cavity 406 in the correct orientation such that the bottom openings 312 of one or more of the wells 304 are in communication with the desired adapter apertures 408. Alternatively, the cavity 406 is able to have any dimensions capable of receiving the well plate 202 and causing one or more of the bottom openings 312 to align with one or more of the adapter apertures 408.

The adapter apertures 408 traverse the width of the adapter plate 204 and comprise a top opening 414 and a bottom opening 416. In some embodiments, each row of the adapter plate 204 comprises sixteen adapter apertures 408. Alternatively, the rows are able to comprise any number of adapter apertures 408 sufficient to receive the output of the bottom openings 312. The apertures 408 are able to be positioned on the adapter plate 204 such that they are in communication with the one or more of the wells 304 of the well plate 202 and one or more of the channels 506 of the drain plate 206 (see FIGS. 5 and 2B) when the plates are coupled together by the coupling mechanism 208. Additionally, if any gaskets 210 are included, the apertures 408 are able to be positioned such that they are in communication with one or more of the gasket apertures 214 when the one or more gaskets 210 are detachably coupled in between the plates. The top openings 414 are dimensioned such that they are able to be in communication with the bottom opening 312 of one or more of the wells 304 and thereby receive the output of vials 104 inserted into the wells 304. Further, it should be noted that although as shown in FIGS. 4A and 4B, each top opening 414 is in communication with two bottom openings 312, one or more of the top openings 414 are able to be in communication with either a single bottom opening 312 or any plurality of bottom openings 312. In other words, although illustrated as a 2:1 ratio in FIG. 4B, the top opening 414 of the adapter apertures 408 is able to be dimensioned to receive the output of more or less than two or all the vials 104 inserted into the wells 304. In some embodiments, the communication is a gas-tight communication. As shown in FIG. 4B, the adapter apertures 408 are substantially perpendicular to the bottom of the adapter plate 204. Alternatively, the adapter apertures 408 are able to be angled. In some embodiments, the number of adapter apertures 408 is based on the number of wells 304.

FIGS. 5A, 5C and 2B illustrate the drainage plate 206 according to some embodiments. The drainage plate 206 comprises a drainage plate body 502, a plurality of channels 506, a plurality of drain tubes 508 and a plurality of output fittings 510. In some embodiments, the drainage plate 206 further comprises a recess 504 sized for receiving one or more gaskets 210 as described above. Each channel 506 is able to be coupled with one or more of the plurality of output fittings 510 through one or more of the plurality of drain tubes 508. In some embodiments, each of the channels 506 comprise one or more holes (not shown) that are the beginning of the one or more of the drain tubes 508. The drain tubes 508 then are able to couple with one or more of the output fittings 510 as shown in FIGS. 5A and 5B. As shown in FIG. 5C, in some embodiments, the output fittings 510 are positioned along the side of the drain plate body 502 in two offset rows. Alternatively, the output fittings 510 are able to be positioned on any portion of the surface of the drain plate body 502 such that the fittings 510 are able to be accessed during operation. In some embodiments, the output fittings 510 are able to be positioned in a number of rows, offset and/or aligned such that the drain tubes 508 are able to couple the fittings 510 with the channels 506. In some embodiments, each output fitting 510 is coupled to a single channel 506. Alternatively, each output fitting 510 is coupled with a plurality of channels 506, and/or each channel 506 is coupled to a plurality of output fittings 510. As a result, each output fitting 510 is able to be in communication with one or more of the channels 506 via the drain tubes 508 such that reagent is able to flow into the channels 506 down the drain tubes 508 out the output fittings 510 and ultimately to waste 512. In some embodiments, the communication is a gas-tight communication. In some embodiments, the plurality of channels 506 are able to be arranged in rows along the surface of the drainage plate body 502 as shown in FIG. 2B. Alternatively, the channels 506 are able to be arranged in another configuration along the surface of the drain plate body 502 as are well known in the art.

As shown in FIG. 5B, the plurality of channels 506 are able to be positioned such that the channels 506 are in communication with one or more of the wells 304 via the adapter apertures 408 (and gasket apertures 214 if included). Specifically, in some embodiments, the channels 506 are positioned such that when the plates 202, 204, 206 are coupled together, each channel 506 is in communication with vials 104 in an individual row of wells 306. Alternatively, one or more of the channels 506 are able to be in communication with a plurality of rows 306 or portions of rows 306 (and the vials 104 inserted therein). Alternatively, one or more of the channels 506 are able to be in communication with any combination of the one or more of the vials 104 within the wells 304. In some embodiments, the communication is gas-tight. As a result, the well drain system 200 enables a user to selectively drain an individual row or rows 306 of vials 104 (or other combination of vials 104) by applying a pressure differential across the vials 104 via the output fittings 510. For example, due to the communication of the system 200, if a negative pressure is applied to one of the output fittings 510, that pressure would be passed through the drain tubes 508 to the channels 506, through the channels 506 to the adapter apertures 408, through the adapter apertures 408 to the wells 304, and through the wells 304 to the vials 104 (including any gasket apertures 214) thereby creating a pressure differential across the vials 104 causing any reagents within them to drain down the system 200 to waste 512. In some embodiments, one or more solenoid valves (not shown) coupled to the output fittings 510 are able to create the pressure differential. Alternatively, other mechanisms capable of creating pressure differentials are able to be used as are well known in the art.

Thus, in operation, when a negative pressure is applied to one or more of the output fittings 510, the gas-tight seal allows that negative pressure to be transmitted through the channel 506 and the adapter aperture 408 (and any gasket apertures 214) to the one or more rows of wells 306 in communication with the channel 506. As a result, a pressure differential is applied across the vials 104 of those rows 306 causing the reagent within those vials 104 to drain out the one or more output fittings 510 and be directed to waste 512. As described above, in some embodiments, the negative pressure is caused by a solenoid valve coupled to the fittings 510 by one or more drain tubes (not shown). Alternatively, a positive pressure is applied to the top of the vials 104 in order to create the draining pressure differential across the vials 104. Alternatively, other devices for creating the negative/positive pressure and pressure differential are able to be used as are well known in the art. As a result, the present application provides the advantage of allowing each of the rows of vials 306 (or other combinations of vials 104) to be selectively and individually drained, instead of having to drain all the wells/vials at the same time. Further, because each of the channels 506 remain coupled to the corresponding rows 306 during operation, the present application provides the advantage of selective draining of individual rows without requiring the rows be repeatedly connected and disconnected to the drains to effectuate the selective draining.

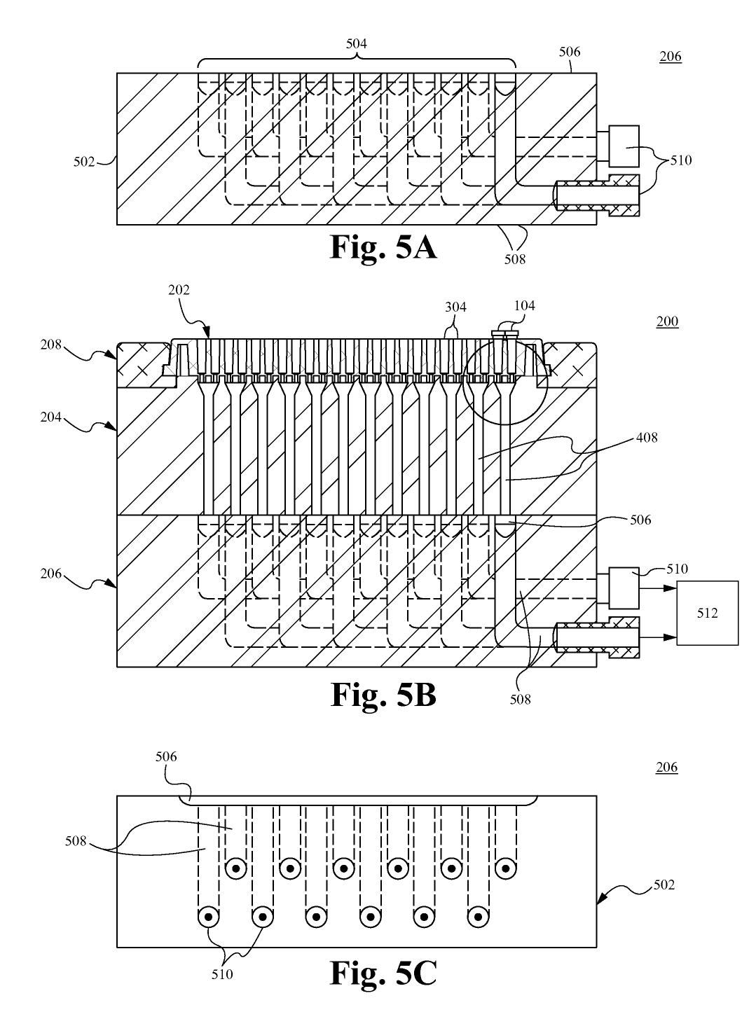

FIG. 6 illustrates a cross sectional view of a vial 104 according to some embodiments. In some embodiments, the vials 104 comprise one or more frits 604, a top support 606, a top opening 608, a bottom opening 610 and one or more narrowing portions 612. The vial 104 is an integral portion of the synthesizer 100. Generally, the polymer chain is formed within the vial 104. More specifically, the vial 104 holds a CPG 602 on which the polymer chain is grown. In some embodiments, a loaded polystyrene support or amino polystyrene support are able to be substituted for the CPG 602 in order to grow the polymer chain Alternatively, the CPG is able to be replaced or supplemented with one or more of a loaded polystyrene support, an amino polystyrene support, or other supports for DNA and/or RNA synthesis as are well known in the art. As stated previously, to create the polymer chain, the CPG 602 is sequentially submerged in various reagent solutions for a predetermined amount of time. With each deposit of a reagent solution, an additional unit is added to the resulting polymer chain Preferably, the CPG 602 is held within the vial 104 by a porous frit 604 positioned within the vial 104. The frit is able to be dimensioned such that the frit 604 wedges itself against the inner walls of the vial 104. In some embodiments, the frit 604 has an elongated shape such that the largest dimension of the frit 604 is the height of the frit 604 from the top surface facing the top opening 608 to the bottom surface facing the bottom opening 610. Alternatively, the frit 604 is able to be sized such that the height of the frit 604 is shorter than the width of the frit 604 thereby increasing the flow of reagent solution through the frit 604 due to the ratio of top/bottom frit surface to the height of the frit 604. Alternatively, the frit 604 is able to comprise any other shape that is able to fit within and seal against the vial 104 as are well known in the art. The top opening 608 is utilized to receive reagents from the dispense lines 106. The bottom opening 610 is utilized to expel the reagents into the drainage system 200. In some embodiments, the bottom opening 610 is sized such that reagents within the vial 104 will not exit through the bottom opening 610 unless a pressure differential is applied across the top and bottom openings of the vial 104. During the dispensing process, the vial 104 is filled with a reagent solution through the top opening 608. Then, during the purging/draining process, the vial 104 is drained of the reagent solution through the bottom opening 610. The frit 604 prevents the CPG 602 or other support from being flushed away during the purging process. A precision bored interior 614 of the vial 104 holds the frit 620 in place and provides a consistent compression and seal with the frit 604. As a result of the precision bored interior 614, there is a consistent flow of the reagent solution through each vial 104 during both the dispensing and purging processes.

The exterior of each vial 104 also has a precise dimension around the support 606. This support 606 fits within the wells 304 within the well plate 202 and provides a gas-tight seal around each vial 104 within the well plate 202. The one or more narrowing portions 612 are able to be dimensioned such that the portions 612 match the interior profile of the wells 304. As a result, the narrowing portions 612 are able to provide distinct pressure points between the vial 104 and the interior of the wells 304 thereby improving the gas-tight seal between the vials 104 and the wells 304. In some embodiments, each vial 104 is formed of polyethylene by a molded process. Alternatively, the vials 104 are able to be formed using any appropriate process and any appropriate material. In some embodiments, the outer dimensions of the vial 104 are able to be configured such that the dimensions are slightly larger than the profile of the wells 304. Thus, in such embodiments, when inserted into the wells 304, the vials 104 are subjected to compression from the walls of the wells 304 improving the gas-tight seal with the wells 304.

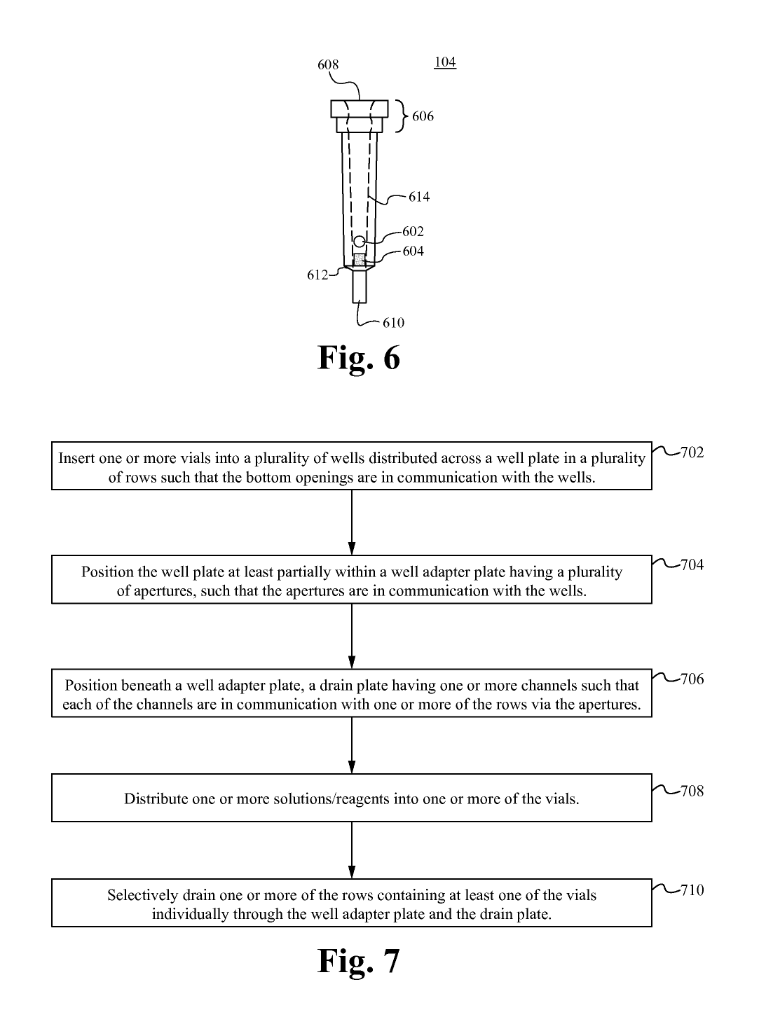

The operation the well drainage system 200 will now be discussed in conjunction with the flow chart shown in FIG. 7. Specifically, one or more vials 104 are inserted into one or more wells 304 distributed across a well plate 202 in a plurality of rows 306 such that the bottom openings 610 are in communication with the wells 304 at the step 702. The well plate 202 is positioned at least partially within a well adapter plate 204 having a plurality of apertures 408, such that the apertures 408 are in communication with the wells 304 at the step 704. The well adapter plate 204 is positioned on top of a drain plate 206 having one or more channels 506 such that each of the channels 506 are in communication with one or more of the rows 306 via the adapter apertures 408 at the step 706. In some embodiments, one or more gaskets 210 are positioned between two or more of the plates 202, 204, 206, such that the a plurality of gasket apertures 214 correspond/communicate with the wells 304 or the adapter apertures 408 and provide a gas-tight seal between one or both of the wells 304 and the apertures 408, and the apertures 408 and the channels 506. In some embodiments, the plates 202 and 204 are detachably coupled together by the coupling mechanism 208 and the plates 204 and 206 are detachably coupled together by one or more additional coupling mechanisms (not shown). When coupled together, the plates 202, 204 and 206 compress the gaskets 210 between the well plate 202 and/or the drain plate 206 and the body 406 of the adapter plate 204 thereby creating a gas-tight connection between the gasket apertures 214, channels 506, the adapter apertures 408, the wells 304 and the vials 104. In some embodiments, with regard to the coupling of the well plate 202 and the adapter plate 204, one or more arches 410 in the top of the adapter plate 204 causes the well plate 202 to flex to conform to the arch 410 thereby increasing the strength of the gas-tight seal. Alternatively, in some embodiments, the adapter plate 204 is able to flex instead of the well plate 202 in order to increase the gas-tight seal. In some embodiments, the adapter plate 204 has an arch 410 in the bottom of the adapter plate body 406 or arches 410 in both the top and bottom of the body 406 such that the gas-tight seal is increased between adapter plate 204 and one or both of the well plate 202 and the drain plate 206 due to either the flexing of the adapter plate 204 or the well and drain plates 202, 206.

One or more solutions/reagents are distributed into one or more of the vials 104 at the step 708. One or more of the rows 306 containing at least one of the vials 104 are selectively and individually drained through the well adapter plate 204 and the drain plate 206 at the step 710. Alternatively, one or more portions of rows 306 (and the vials 104 inserted therein) are selectively and individually drained. Alternatively, any combination of the vials 104 within the plurality of wells 304 are selectively and individually drained. In some embodiments, the drainage is produced by a solenoid valve coupled to one or more of the fittings 510 creating a pressure differential across the top opening 608 and bottom opening 610 of the vials 104 via the well drain system 200. Alternatively, a vacuum and or other pressure mechanisms, as are well known in the art are able to be used to create the pressure differential. Alternatively, gravity and or mechanical means cause the vials 104 to drain. In some embodiments, the individual rows 306 are able to be simultaneously drained. Accordingly, the present application provides the advantage of a well drainage system that allows the selective draining of individual rows of vials instead of having to drain all the vials at once. Further, the present application provides the additional advantage of each of the rows of vials always being coupled to the well drainage system 200 described above during operation. As a result, it is not necessary to reconnect or disconnect drain tubes or other draining elements to the vials when drainage is desired.

The present application has numerous advantages. Specifically, the present application provides the advantage of being able to selectively drain individual rows of a vial/well matrix on a well plate. This allows greater control and flexibility when performing synthesis operations. Also, because each row has a dedicated drain channel/fitting the present application provides the benefits of individual row draining without the drawback of having to connect a desired bank of vials to a draining portion each time draining is desired. Instead, as described above, each row is always connected to a draining portion while in operation. Further, the present application is able to better facilitate the efficient drainage of the vials by utilizing an arched well adapter plate (while having a more or less rigid well plate and/or drain plate). Specifically, when coupled together with the well and/or drain plates the arched adapter plate provides the advantage of better gas-tight seal of increased strength between wells and rows of wells thereby minimizing the possibility of leakage and cross contamination. Moreover, the present application provides the advantage of a well plate chamfer and matching well adapter plate cavity such that the well plate cannot inadvertently be oriented in the well plate adapter incorrectly. Finally, the vials of the present application provide the advantage of having one or more narrowing points, a top seal portion and a specifically sized bottom opening. Specifically, the one or more narrowing points and top seal portion provide multiple distinct pressure points with the wells such that the vials are securely sealed to the wells in a gas-tight manner. Further, the bottom opening is sized such that reagents/solutions and other content will not exit through the bottom opening due to gravity unless a pressure differential is applied across the opening. Accordingly, the present application provides numerous advantages over the prior art.

The present application has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention. Specifically, it will be apparent to one of ordinary skill in the art that the device of the present application could be implemented in several different ways and the embodiments disclosed above are only exemplary of the preferred embodiment and the alternate embodiments of the invention and is in no way a limitation.

1. A well drain system for use with a synthesizer containing one or more vials comprising:
a. a well plate having a plurality of wells distributed across the well plate in a plurality of rows;
b. a well adapter plate having a plurality of apertures, wherein the apertures are in communication with the wells; and
c. a drain plate having one or more channels that are each in communication with one or more of the rows via the apertures;
wherein the well plate, well adapter plate and drain plate are detachably coupled such that individual rows of the well plate are able to be selectively drained.

2. The system of claim 1 wherein the well plate is substantially rectangular.

3. The system of claim 2 wherein the wells are arranged on the well plate in a linear matrix including the plurality of rows.

4. The system of claim 3 wherein the well plate further comprises an angled chamfer along a corner of the well plate having a preselected angle and length.

5. The system of claim 4 wherein the well adapter plate further comprises a cavity for receiving the well plate, wherein the cavity is dimensioned such that the angled chamfer only permits the well plate to couple with the well adapter plate within the cavity in a single orientation.

6. The system of claim 1 wherein the well plate comprises 2, 4, 6, 8, 96, 192, 384 or 1536 wells.

7. The system of claim 1 wherein the well adapter plate further comprises an adapter body having a first end and a second end, and further wherein the adapter body arches between the first end and the second end such that an increased seal is created around the wells when the well adapter plate is coupled to the well plate and/or the drain plate.

8. The system of 7 claim wherein the highest point of the arch within the adapter body is substantially in the center of the adapter body.

9. The system of 7 claim wherein the arch is a downward arch such that the lowest point of the arch within the adapter body is substantially in the center of the adapter body.

10. The system of claim 8 wherein the adapter body is substantially rectangular and the first end and second end correspond to the two shorter sides of the adapter body.

11. The system of claim 8 wherein the adapter body is substantially rectangular and the first end and second end correspond to the two longer sides of the adapter body.

12. The system of claim 10 wherein the adapter body further comprises one or more additional arches oriented along one or more second axis distinct from a first axis of the arch.

13. The system of claim 12 wherein at least one of the one or more additional arches is oriented perpendicular to the arch.

14. The system of claim 7 further comprising one or more gaskets having a plurality of gasket apertures that correspond to the wells or the apertures, wherein the gaskets are positioned between two or more of the well plate, the well adapter plate and the drain plate, wherein the gaskets thereby provide a gas-tight seal between one or both of the wells and the apertures, and the apertures and the channels.

15. The system of claim 14 wherein the drain plate further comprises a recess on a top surface of the drain plate for receiving at least a portion of at least one of the gaskets.

16. The system of claim 15 further comprising one or more coupling mechanisms for coupling the well plate, well adapter plate, drain plate and gaskets together.

17. The system of claim 16 wherein the coupling mechanisms are sized such that when in a closed position the coupling mechanisms cause the well plate, well adapter plate, drain plate and gaskets to couple to each other forming a gas-tight seal wherein the arch of the well adapter plate compresses two or more of the group consisting of the gaskets, the well plate and the drain plate.

18. The system of claim 17 wherein the one or more vials each have a hollow body, one or more fits and one or more narrowing points along the body such that the vials form an gas-tight seal with each of the wells when inserted into the wells.

19. A method of draining a well drain system for use with a synthesizer containing one or more vials having bottom openings, the method comprising:
a. inserting the one or more vials into a plurality of wells distributed across a well plate in a plurality of rows such that the bottom openings are in communication with the wells;
b. positioning the well plate at least partially within a well adapter plate having a plurality of apertures, such that the apertures are in communication with the wells;
c. positioning beneath the well adapter plate a drain plate having one or more channels such that each of the channels are in communication with one or more of the rows via the apertures;
d. distributing one or more solutions into one or more of the vials; and
e. selectively draining one or more of the rows containing at least one of the vials individually through the well adapter plate and the drain plate.

20. The method of claim 19 wherein the one or more rows are selectively drained via pressure differential.

21. The method of claim 20 wherein the well plate is substantially rectangular.

22. The method of claim 20 wherein the wells are arranged on the well plate in a linear matrix including the plurality of rows.

23. The method of claim 22 wherein the well plate further comprises an angled chamfer along a corner of the well plate having a preselected angle and length.

24. The method of claim 23 wherein the well adapter plate further comprises a cavity for receiving the well plate, wherein the cavity is dimensioned such that the angled chamfer only permits the well plate to couple with the well adapter plate within the cavity in a single orientation.

25. The method of claim 20 wherein the well plate comprises 2, 4, 6, 8, 96, 192, 384 or 1536 wells.

26. The method of claim 20 wherein the well adapter plate further comprises an adapter body having a first end and a second end, and further wherein the adapter body arches between the first end and the second end such that an increased seal is created around the wells when the well adapter plate is coupled to the well plate and/or the drain plate.

27. The method of claim 26 wherein the highest point of the arch within the adapter body is substantially in the center of the adapter body.

28. The method of claim 26 wherein the arch is a downward arch such that the lowest point of the arch within the adapter body is substantially in the center of the adapter body.

29. The method of claim 27 wherein the adapter body is substantially rectangular and the first end and second end correspond to the two shorter sides of the adapter body.

30. The method of claim 27 wherein the adapter body is substantially rectangular and the first end and second end correspond to the two longer sides of the adapter body.

31. The method of claim 29 wherein the adapter body further comprises one or more additional arches oriented along one or more second axis distinct from a first axis of the arch.

32. The method of claim 31 wherein at least one of the one or more additional arches is oriented perpendicular to the arch.

33. The method of claim 26 further comprising positioning one or more gaskets between two or more of the well plate, the well adapter plate and the drain plate, wherein the gaskets have a plurality of gasket apertures that correspond to the wells or the apertures and provide a gas-tight seal between one or both of the wells and the apertures, and the apertures and the channels.

34. The method of claim 33 wherein the drain plate further comprises a recess on a top surface of the drain plate for receiving at least a portion of at least one of the gaskets.

35. The method of claim 34 further comprising coupling the well plate, well adapter plate, drain plate and gaskets together with one or more coupling mechanisms.

36. The method of claim 35 wherein when the coupling mechanisms are in a closed position, the coupling mechanisms cause the well plate, well adapter plate, drain plate and gaskets to couple to each other forming a gas-tight seal such that the arch of the well adapter plate compresses two or more of the group consisting of the gaskets, the well plate and the drain plate.

37. The method of claim 36 wherein the one or more vials each have a hollow body, one or more frits and one or more narrowing points along the body such that the vials form an gas-tight seal with each of the wells when inserted into the wells.

38. A well adapter plate for receiving one or more vials in a well drain system comprising:
a. a plate body having a first end and a second end; and
b. one or more apertures within the plate body;
wherein the plate body arches between the first end and the second end such that an increased seal is created around the apertures when the well adapter plate is coupled within the well drain system.

39. The adapter plate of claim 38 wherein the highest point of the arch within the plate body is substantially in the center of the plate body.

40. The adapter plate of claim 38 wherein the arch is a downward arch such that the lowest point of the arch within the plate body is substantially in the center of the plate body.

41. The adapter plate of claim 39 wherein the plate body is substantially rectangular and the first end and second end correspond to the two shorter sides of the plate body.

42. The adapter plate of claim 39 wherein the plate body is substantially rectangular and the first end and second end correspond to the two longer sides of the plate body.

43. The adapter plate of claim 41 wherein the plate body further comprises one or more additional arches oriented along one or more second axis distinct from a first axis of the arch.

44. The adapter plate of claim 43 wherein at least one of the one or more additional arches is oriented perpendicular to the arch.

45. The adapter plate of claim 44 wherein the plate body further comprises a cavity for receiving a well plate having a plurality of wells and an angled chamfer along one corner of the well plate, wherein the cavity is dimensioned such that the angled chamfer only permits the well plate to couple with the adapter plate within the cavity in a single orientation.

46. The adapter plate of claim 45 wherein each of the apertures have a top opening sized and positioned to receive the output of one or more of the wells.

47. A well drain system for use with a synthesizer containing one or more vials comprising:
a. a substantially rectangular well plate having a plurality of wells for receiving the one or more vials thereby forming a gas-tight seal, wherein the wells are distributed across the well plate in a matrix having a plurality of rows;
b. a well adapter plate having an arched body and a plurality of apertures, wherein the apertures are in gas-tight communication with the wells such that each of the apertures receive the output of less than all of the vials via the wells;
c. a drain plate having one or more channels that are each in communication with one or more of the rows via the apertures such that each channel is coupled to less than all of the one or more rows forming a first gas-tight seal; and
d. at least one coupling device for detachably coupling the well plate forming a second gas-tight seal, well adapter plate and drain plate to each other such that a pressure differential applied to one of the channels is able to selectively drain the vials in less than all of the rows of the well plate.

48. The system of claim 47 wherein the well plate further comprises an angled chamfer along a corner of the well plate having a preselected angle and length.

49. The system of claim 48 wherein the well adapter plate further comprises a cavity for receiving the well plate, wherein the cavity is dimensioned such that the angled chamfer only permits the well plate to couple with the well adapter plate within the cavity in a single orientation.

50. The system of claim 49 further comprising one or more gaskets having a plurality of gasket apertures that correspond to the wells or the apertures, wherein the gaskets are positioned between two or more of the well plate, the well adapter plate and the drain plate, wherein the gaskets thereby increase the gas-tight seal between one or both of the wells and the apertures, and the apertures and the channels.

51. The system of claim 50 wherein the drain plate further comprises a recess on a top surface of the drain plate for receiving at least a portion of at least one of the gaskets.

52. The system of claim 51 wherein the coupling device is one or more clamps that are sized such that when in a closed position the clamps cause the well plate, well adapter plate, drain plate and gaskets to couple to each other forming a gas-tight seal wherein the arch of the well adapter plate compresses two or more of the group consisting of the gaskets, the well plate and the drain plate.

53. The system of claim 52 wherein the one or more vials each have a hollow body, one or more frits and one or more narrowing points along the body such that the vials form an gas-tight seal with each of the wells when inserted into the wells.

54. The system of claim 47 wherein the well plate comprises 2, 4, 6, 8, 96, 192, 384 or 1536 wells.
